(19) United States
(12) Patent Application Publication
(10) Pub. No.: US 2023/0392824 A1
(43) Pub. Date: Dec. 7, 2023

(54) SOUND-REDUCING AIR PURIFICATION UNIT

(71) Applicant: Price Industries, Inc., Suwanee, GA (US)

(72) Inventors: Nolan Hosking, Alpharetta, GA (US); Michael Holliday, Auburn, GA (US); Mauricio Salinas, Winnipeg (CA); Ankit Bhardwaj, Winnipeg (CA); Chris Dziedzic, Winnipeg (CA); Mark Mahon, Winnipeg (CA)

(21) Appl. No.: 18/203,157

(22) Filed: May 30, 2023

Related U.S. Application Data
(60) Provisional application No. 63/347,733, filed on Jun. 1, 2022.

(51) Int. Cl. F24F 13/24; F24F 8/108; B01D 46/42; B01D 46/44; B03C 3/011; B01D 46/00

(52) U.S. Cl. CPC F24F 13/24; F24F 8/108; B01D 46/4236; B01D 46/44; B03C 3/011; B01D 46/0028; B01D 46/0049; F24F 2013/242; B01D 2273/30; B01D 2279/65

(57) ABSTRACT

Aspects of a sound-reducing air purification unit. In some units, the sound-reducing air purification unit can include a filter, a blower that causes air to flow through the filter and into an inlet of the blower, a sound reduction unit between the filter and an outlet, to absorb sound emitted by the blower, a discharge channel that channels the air expelled from the blower to a discharge grille, sound-reducing media positioned on either side of the discharge channel, to absorb sound emitted by the blower within the discharge channel, and a discharge grille that allows the air to flow from the discharge channel into the outlet.

This application claims priority to co-pending U.S. provisional application entitled, “SOUND-REDUCING AIR PURIFICATION UNIT,” having Ser. No. 63/347,733, filed Jun. 1, 2022, which is entirely incorporated herein by reference.

### BACKGROUND

In indoor settings like offices, circulated air can include dust, airborne pathogens, and other airborne particles that can have a negative effect on health. Thus, steps can be taken to ensure that the air is clean and safe. Unfortunately, filtration systems installed in indoor settings are often ineffectual because they operate at low efficiencies, if any filtration systems are installed at all. High-efficiency filtration is rarely present in indoor settings and adding high-efficiency filtration to those settings may not be feasible. In addition, filtration systems may only filter air without purifying and clearing that air. Existing filtration systems may also emit excessive and unwanted noise.

### BRIEF DESCRIPTION OF THE DRAWINGS

For a more complete understanding of the embodiments and the advantages thereof, reference is now made to the following description, in conjunction with the accompanying figures briefly described as follows:

FIGS. 1A-C illustrate examples of perspective views of the sound-reducing air purification unit, according to various embodiments of the present disclosure.

FIGS. 2A-C illustrate examples of top views of the sound-reducing air purification unit, according to various embodiments of the present disclosure.

FIGS. 3A-B illustrate examples of bottom views of the sound-reducing air purification unit, according to various embodiments of the present disclosure.

FIGS. 4A-C illustrate examples of first side views of the sound-reducing air purification unit, according to various embodiments of the present disclosure.

FIGS. 5A-C illustrate examples of second side views of the sound-reducing air purification unit, according to various embodiments of the present disclosure.

FIGS. 6A-C illustrate examples of third side views of the sound-reducing air purification unit, according to various embodiments of the present disclosure.

FIGS. 7A-C illustrate examples of fourth side views of the sound-reducing air purification unit, according to various embodiments of the present disclosure.

FIG. 8 illustrates an example of an isolated perspective view of a control module of the sound-reducing air purification unit, according to various embodiments of the present disclosure.

FIG. 9 illustrates an example of an isolated perspective view of an ultraviolet module of the sound-reducing air purification unit, according to various embodiments of the present disclosure.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Disclosed herein is a sound-reducing air purification unit that can efficiently filter and purify air in a room or other setting, without the excess noise generated by blowers or other air circulation devices. The sound-reducing air purification unit can filter air at a higher efficiency than filtration solutions in typical settings. For example, the sound-reducing air purification unit can use a high efficiency particulate air (HEPA) filter to continually clean the air. As another example, the sound-reducing air purification unit can use lower-efficiency filter in addition to HEPA filter to filter larger particles from air before the air enters the HEPA filter, thereby increasing a usable life of the HEPA filter. The sound-reducing air purification unit can substantially increase the quantity of air changes in a setting relative to typical settings. The sound-reducing air purification unit can even surpass the standards set by The American Society of Heating, Refrigerating and Air-Conditioning Engineers (ASHRAE) for number of HEPA-filtered air changes per hour. What is more, the sound-reducing air purification unit does not emit excess noise that may occur with air purification units.

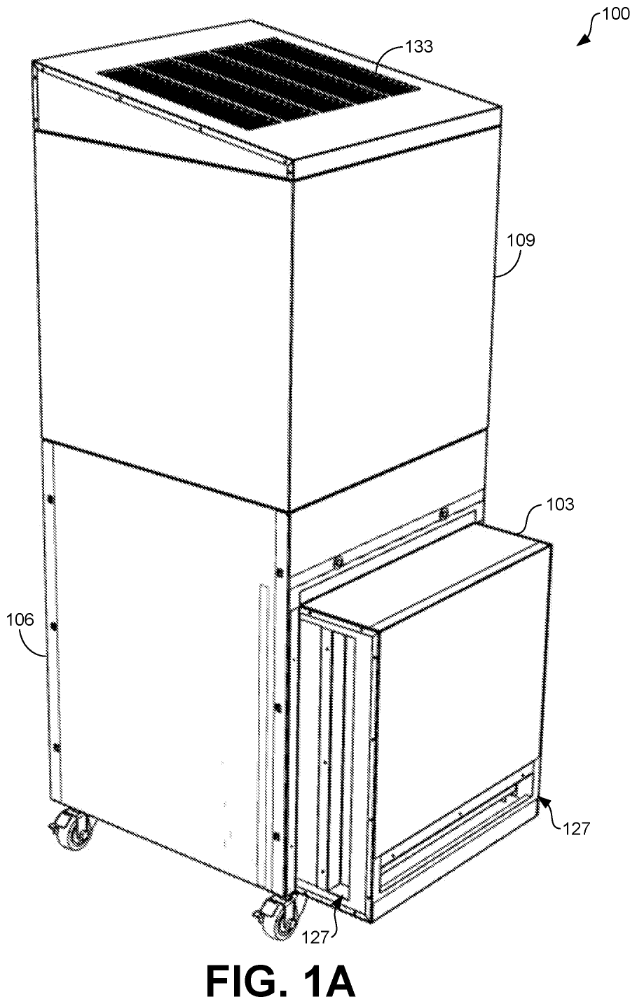

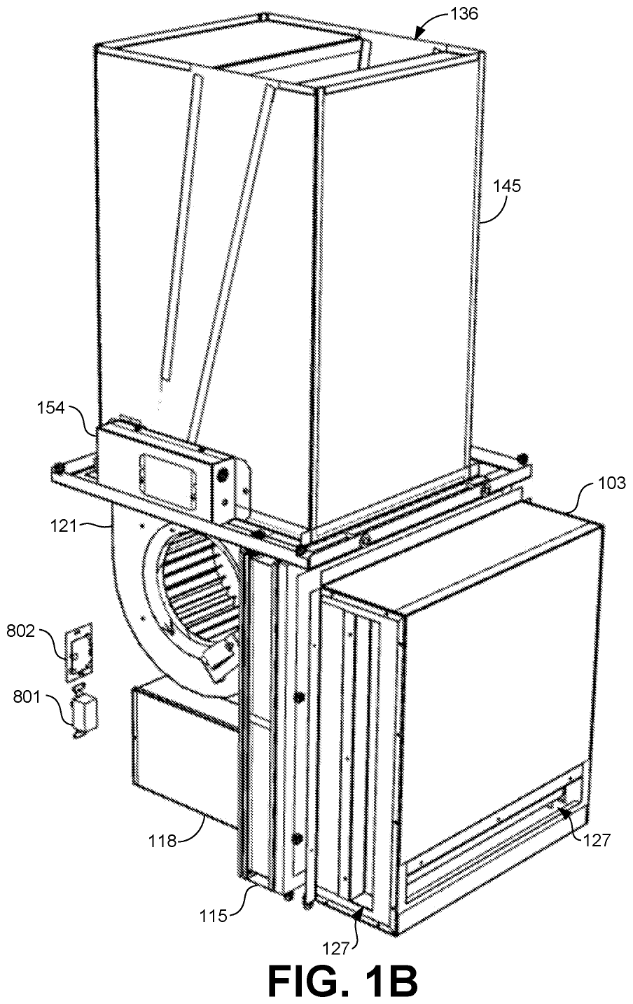

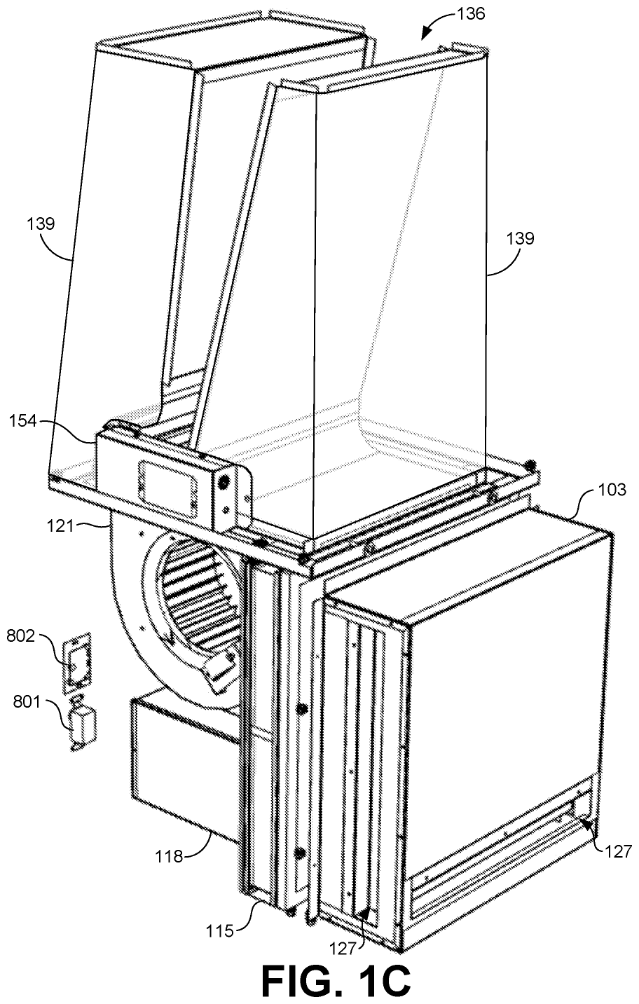

FIGS. 1A-C illustrate examples of perspective views of a sound-reducing air purification unit 100. FIG. 1A shows an outside of the sound-reducing air purification unit 100, while FIGS. 1B and 1C show internal components of the sound-reducing air purification unit 100. An exterior of the sound-reducing air purification unit 100 can include a lower sound reduction unit 103, a lower housing 106, and an upper housing 109.

The lower housing 106 can enclose a lower chamber 112. The lower chamber 112 can include a filtration apparatus 115, a control module 118, a blower 121, and a bipolar ionization unit 124.

The filtration apparatus 115 can be any device designed to remove airborne particulate matter from air or other gasses that flows through the filtration apparatus 115.

The control module 118 can include various components used to control operation of the sound-reducing air purification unit 100.

The blower 121 can create pressure that pulls air through the filtration apparatus 109 and into the lower chamber 112. The blower 121 can be located in the lower chamber 112 proximate to the filtration apparatus 115. The blower 121 can include a motor that can cause an impeller within the blower 121 to spin and pull air into one or more inlets on the sides of the blower 121. The impeller can then expel the air from an outlet at a top of the blower. The blower 121 can be accessed for maintenance by removing an access panel.

While in FIGS. 1-7 the blower 121 is a centrifugal blower, the blower 121 can be any system designed to push and pull air. For example, the blower 121 can be a centrifugal blower, a high-speed blower, an axial fan, a backwards inclined fan, a plug fan, or any other suitable type of blower. The blower 121 used can depend on the components used in the filtration apparatus 115. For example, if the filtration apparatus 115 includes a HEPA filter, a blower 121 can be used that is designed to intake air at a velocity suitable for moving that air through the HEPA filter.

The bipolar ionization unit 124 can treat the air that has been filtered through the filtration apparatus 115. The bipolar ionization unit 124 can be any device designed to produce ions that can cluster around airborne pathogens and cause other airborne particles to clump together. As an example, the bipolar ionization unit 124 can do so by creating and emitting positive and negative oxygen ions without also creating ozone. In some examples, a bipolar ionization unit 124 can be used that requires little-to-no servicing or maintenance.

The lower sound reduction unit 103 can reduce sound emitted by the blower 121. The lower sound reduction unit 103 can include front and side panels that can each include a slot 127. A bracket 130 can be attached to an inner surface of each of the front and side panels adjacent to the slots 127. Air can be pulled by the blower 121 through the slots 127 and around the brackets 130 into an interior of the lower sound reduction unit 103. The brackets 130 can impede a path of sound emitted by the blower 121 to hinder sound from escaping the sound-reducing air purification unit 100 through the slots 127. In one example, the brackets 130 can provide a visual obstruction from the outside of the sound-reducing air purification unit 100 while permitting air to enter the sound-reducing air purification unit 100 through the slots 127 and round the brackets 130.

The upper housing 109 can include a discharge grille 133. The discharge grille 133 can be a grating, screen, register, or other group of openings through which air can exit the sound-reducing air purification unit 100. Air can exit the sound-reducing air purification unit 100 through the discharge grille 133 at an upward angle relative to an angle at which air enters the sound-reducing air purification unit 100. That way, air that has been purified by the sound-reducing air purification unit 100 does not immediately re-enter the sound-reducing air purification unit 100.

The upper housing 109 can enclose a discharge channel 136 and sound-reducing chambers 139. The discharge channel can be defined by a pair of baffles 148. Air expelled by the blower 121 can enter the discharge channel 136 and be expelled from the sound-reducing air purification unit 100 through the discharge grille 133.

The sound-reducing air purification unit can reduce sound emitted by the blower 121 that may otherwise escape through the discharge channel 136. For example, the sound reducing chambers 139 can include sound-reducing media 142 to reduce sound emitted by the blower 121. In that example, at least one of the baffles 148 can include a plurality of perforations that can allow sound generated by the blower 121 to be absorbed into the sound-reducing media 142 and thereby reduced. However, any suitable form of sound reduction may be employed.

The sound-reducing chambers 139 can include sound-reducing media 142 enclosed by an inner casing 145. The sound-reducing media 142 can include any sound deadening or reduction material such as, for example, fiberglass, polyurethane foam, or cellulose.

A lower portion of the discharge channel 136 can have a narrow width compared to an upper portion of the discharge channel 136 such that the discharge channel 136 widens as air travels upward after being expelled by the blower 121. The narrow width of the lower portion of the discharge chamber 136 can constrict air entering the channel to force sound into the sound-reducing chambers 139. The lower portion of the discharge chamber 136 can still have a great enough width to allow for an optimal pressure drop.

The ultraviolet lamp 151 can treat air that has been filtered through the filtration apparatus 115 and expelled by the blower 121 into the discharge channel 136. The ultraviolet lamp 151 can be any device designed to emit ultraviolet radiation capable of inactivating airborne pathogens. For example, the ultraviolet lamp 151 can be a UV-C lamp. The ultraviolet lamp 151 can be secured to the ultraviolet module 154. The ultraviolet lamp 151 can be accessed for removal and replacement by removing one or more access panels. In some examples, however, the ultraviolet lamp 151 may be omitted, or another air treatment component may be used in its place.

The ultraviolet module 154 can facilitate operation of the ultraviolet lamp 151. For example, the ultraviolet module 154 can include one or more components that enable the ultraviolet lamp 151 to function. The ultraviolet lamp 151 can be secured to an inner surface of the upper housing 109.

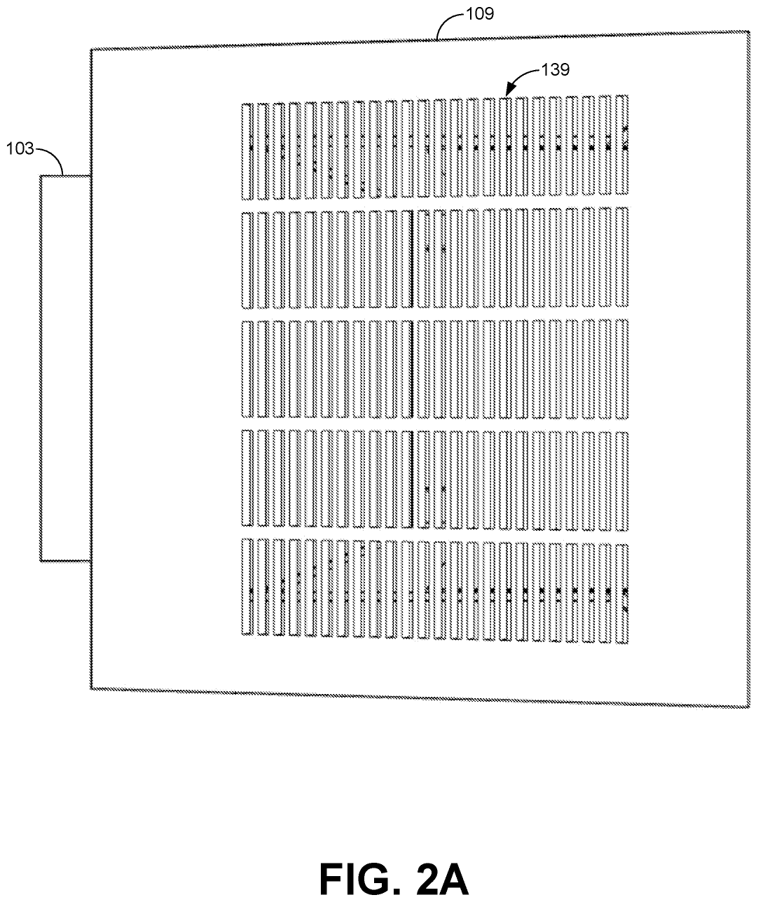

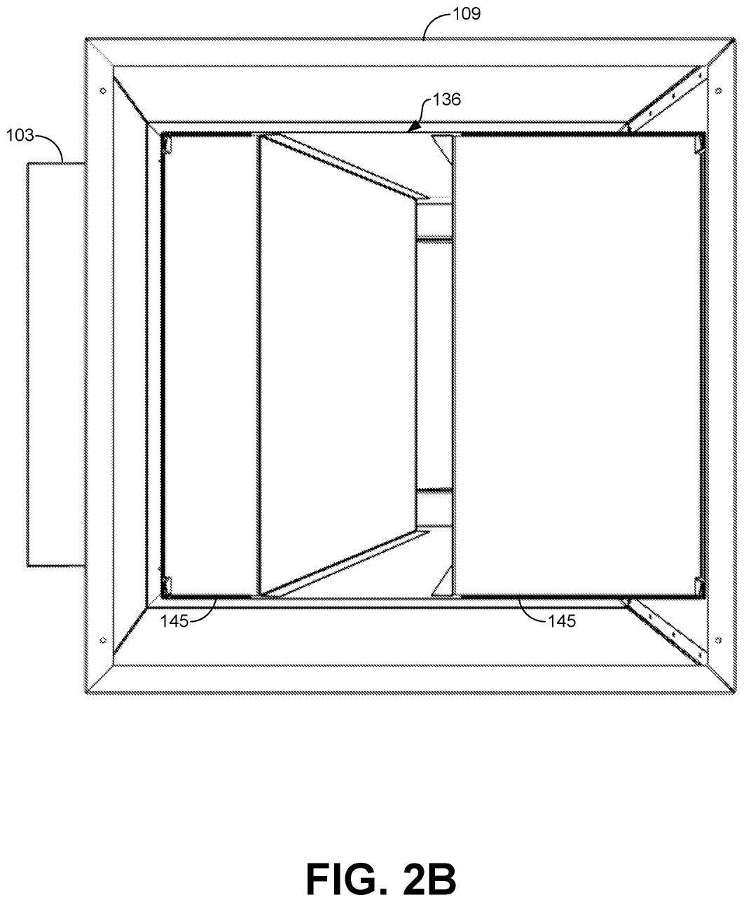

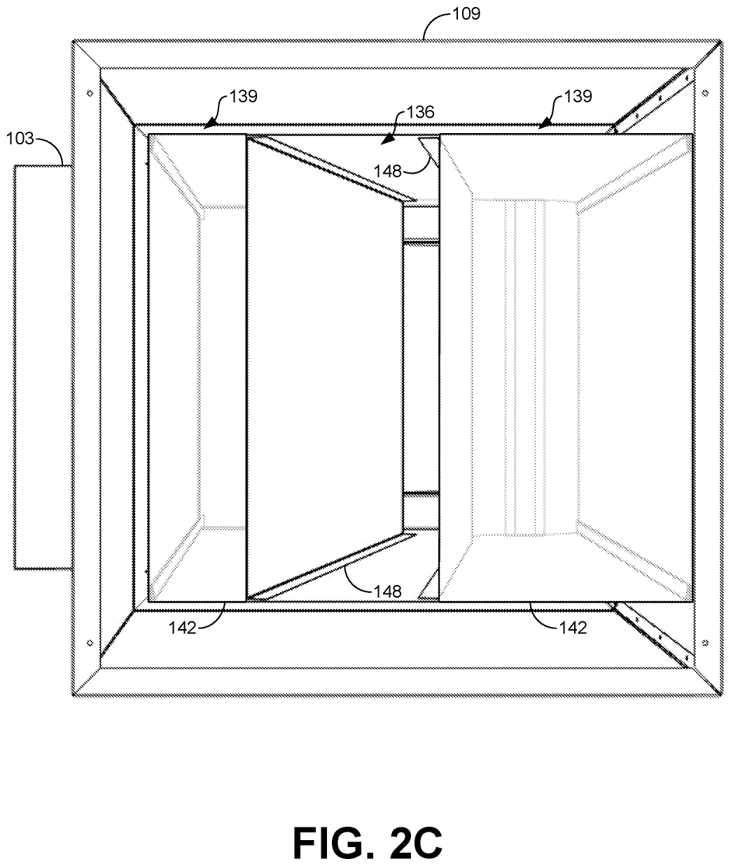

FIGS. 2A-C illustrate examples of top views of the sound-reducing air purification unit, according to various embodiments of the present disclosure. FIG. 2A illustrates an outside of the sound-reducing air purification unit 100 from a top view. FIGS. 2B and 2C illustrate internal components of the sound-reducing air purification unit 100 from a top view.

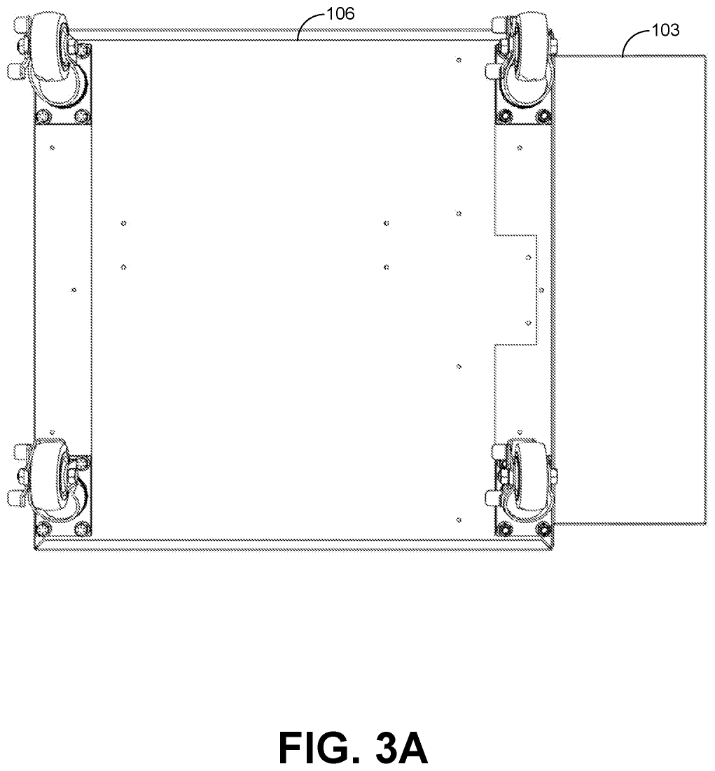

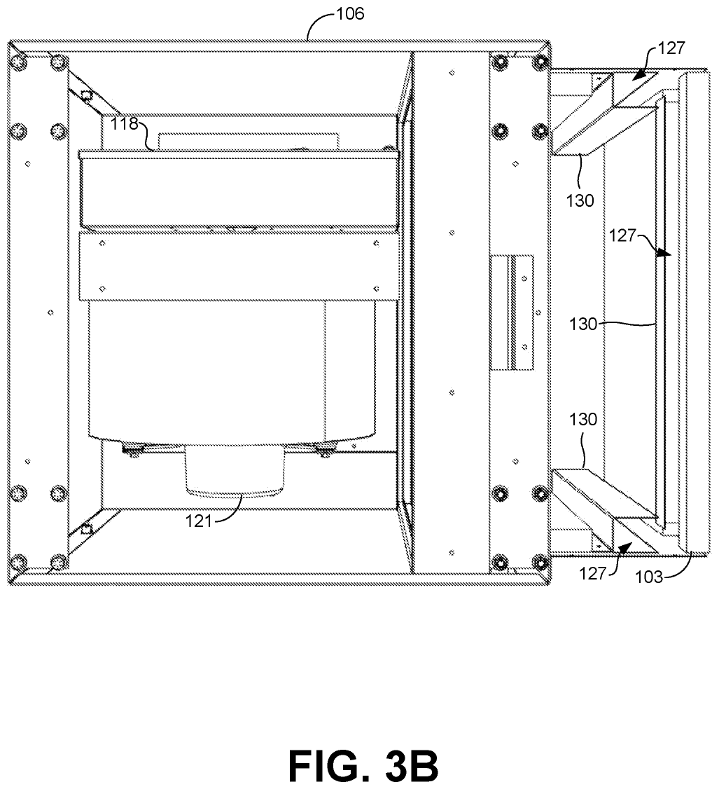

FIGS. 3A-B illustrate examples of bottom views of the sound-reducing air purification unit, according to various embodiments of the present disclosure. FIG. 3A illustrates an outside of the sound-reducing air purification unit 100 from a bottom view. FIG. 3B illustrates internal components of the sound-reducing air purification unit 100 from a bottom view.

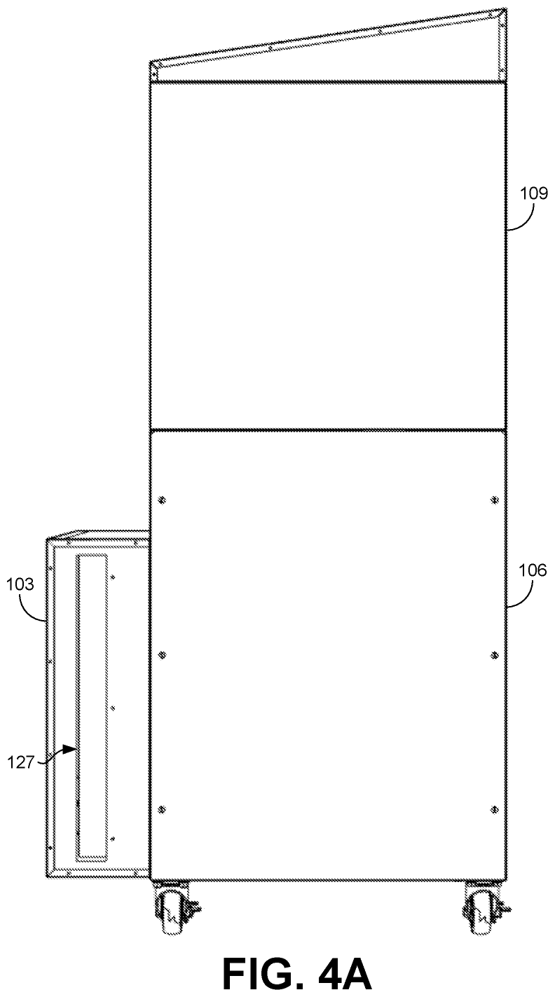

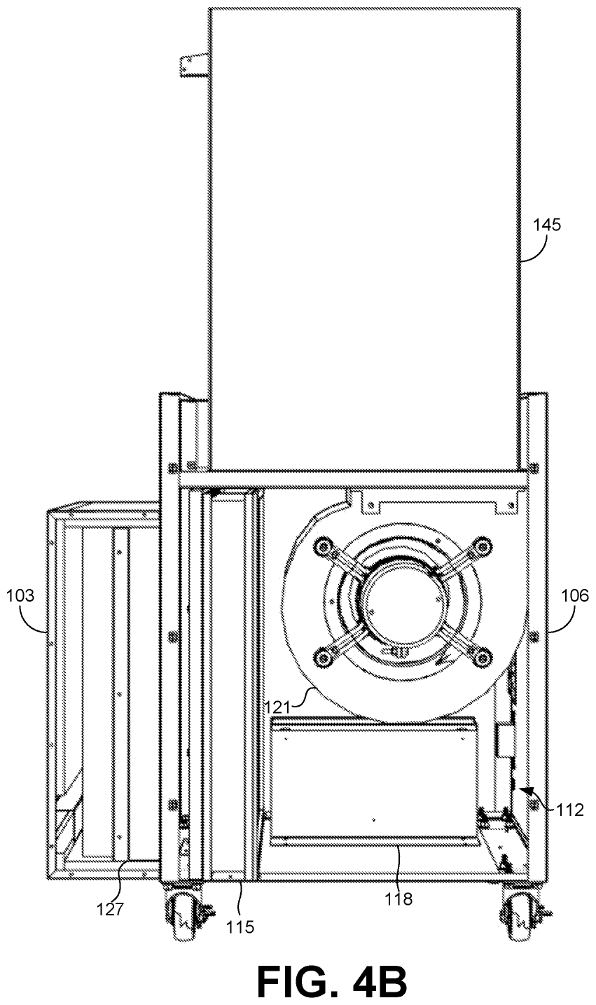

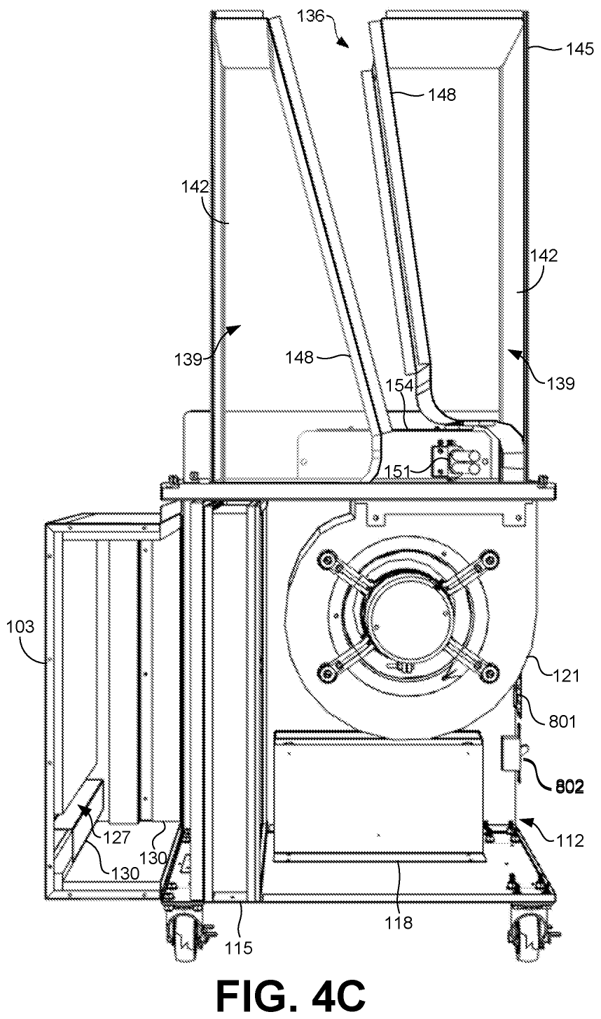

FIGS. 4A-C illustrate examples of first side views of the sound-reducing air purification unit, according to various embodiments of the present disclosure. FIG. 4A illustrates an outside of the sound-reducing air purification unit 100 from a first side view. FIGS. 4B and 4C illustrate internal components of the sound-reducing air purification unit 100 from a first side view.

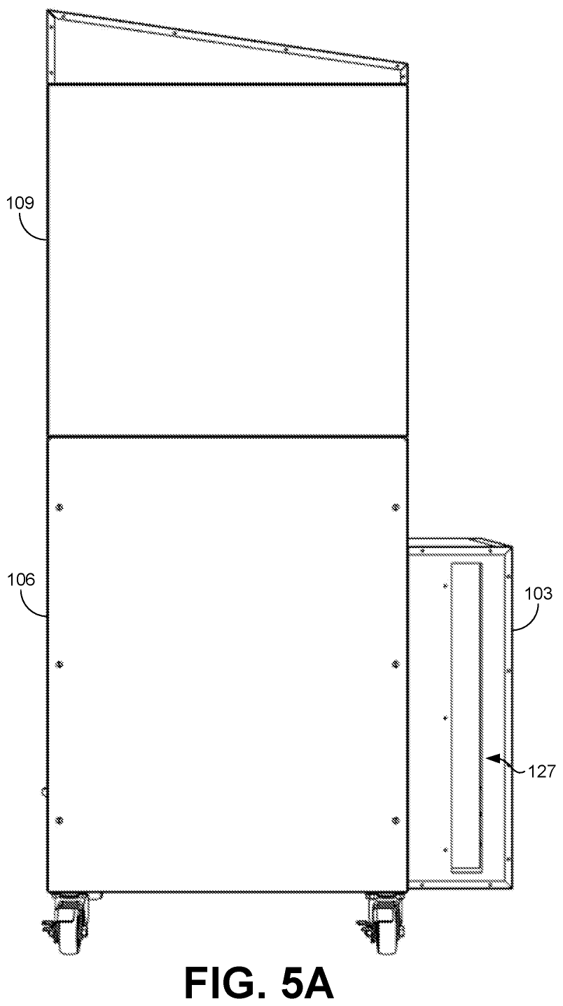

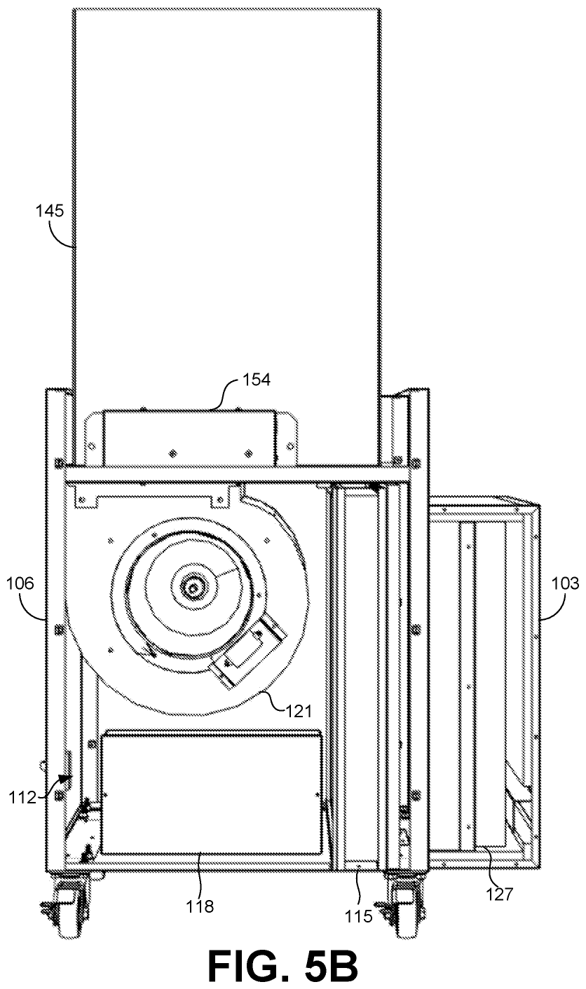

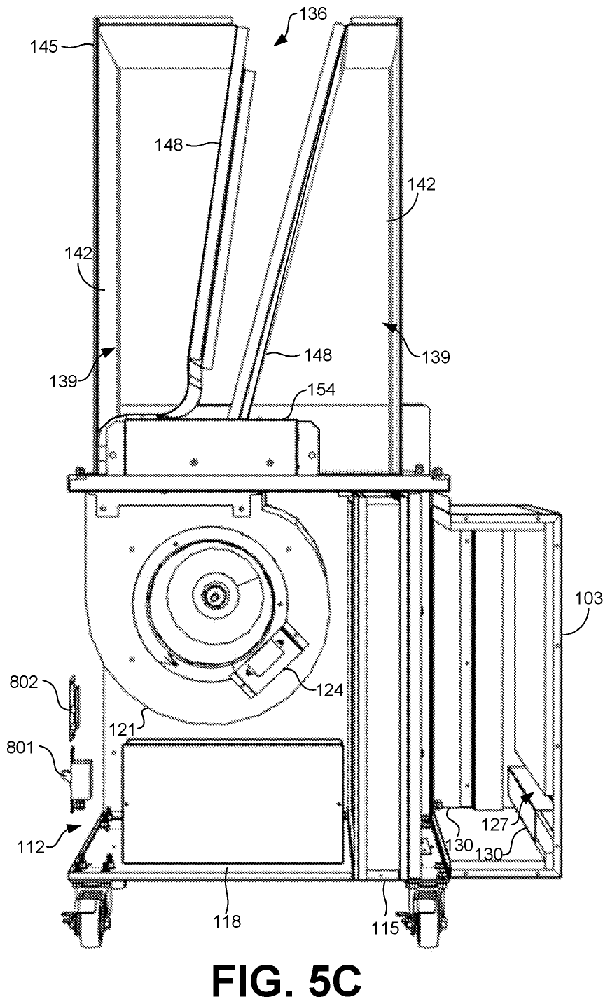

FIGS. 5A-C illustrate examples of second side views of the sound-reducing air purification unit, according to various embodiments of the present disclosure. FIG. 5A illustrates an outside of the sound-reducing air purification unit 100 from a second side view. FIGS. 5B and 5C illustrate internal components of the sound-reducing air purification unit 100 from a second side view.

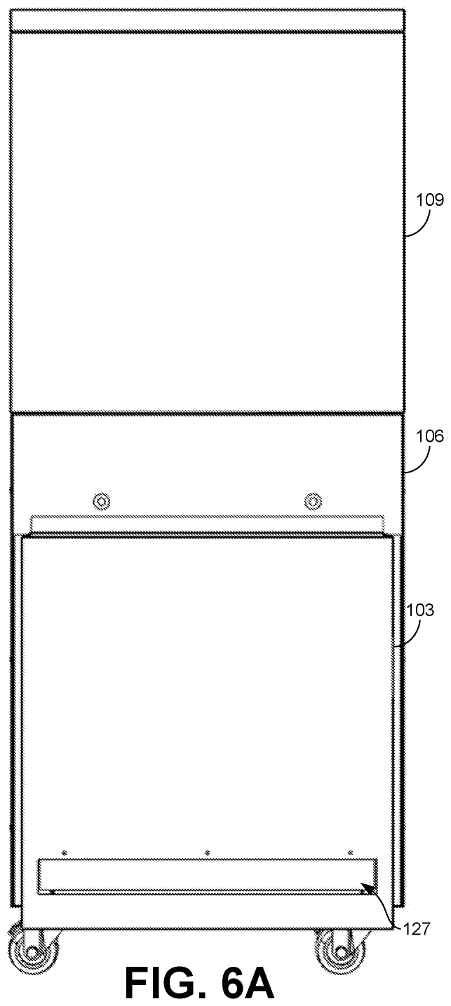

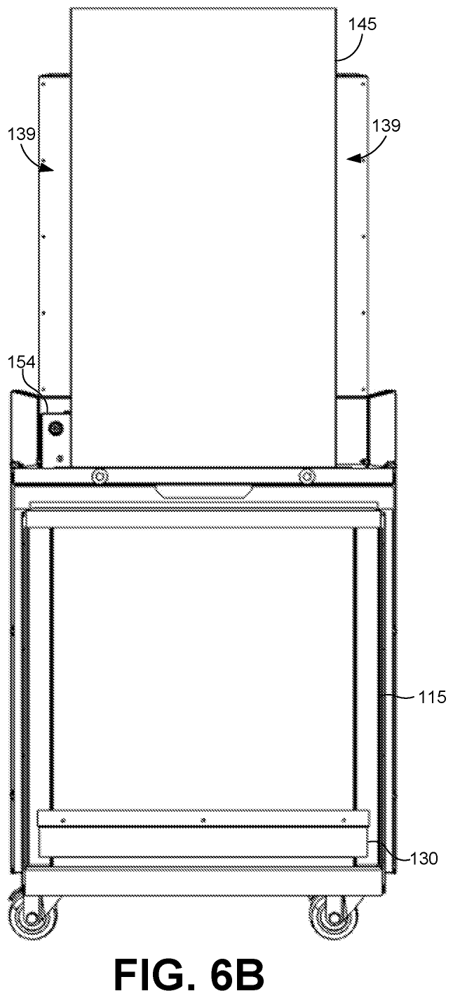

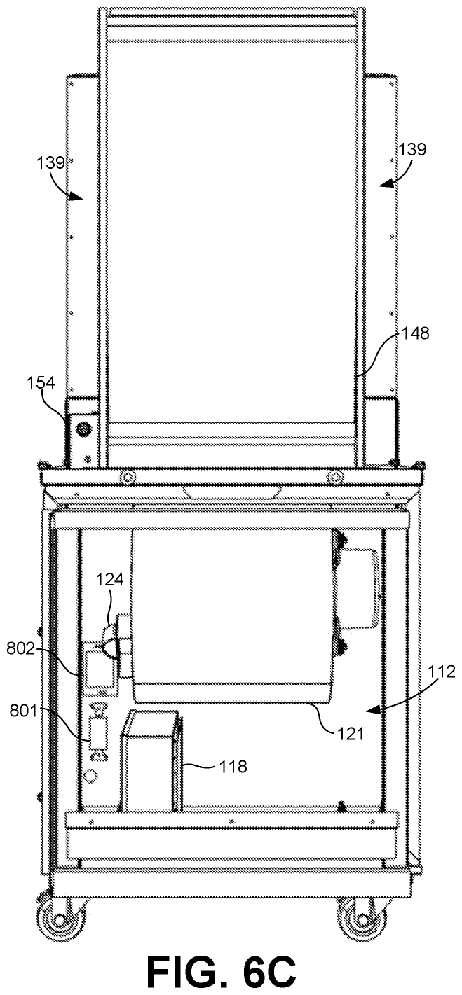

FIGS. 6A-C illustrate examples of third side views of the sound-reducing air purification unit, according to various embodiments of the present disclosure. FIG. 6A illustrates an outside of the sound-reducing air purification unit 100 from a third side view. FIGS. 6B and 6C illustrate internal components of the sound-reducing air purification unit 100 from a third side view.

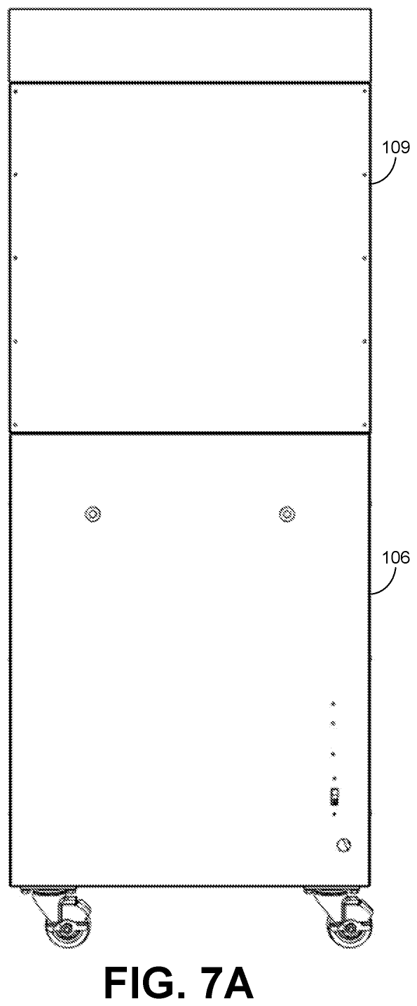

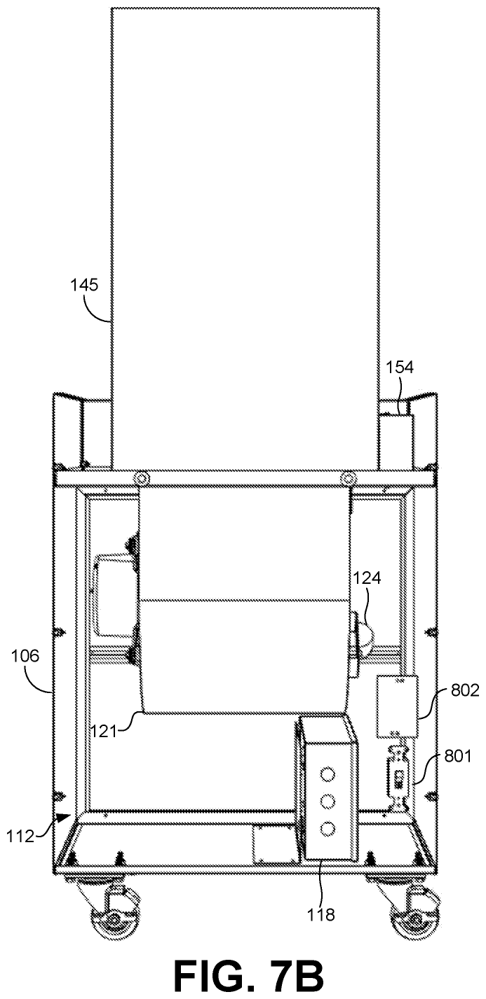

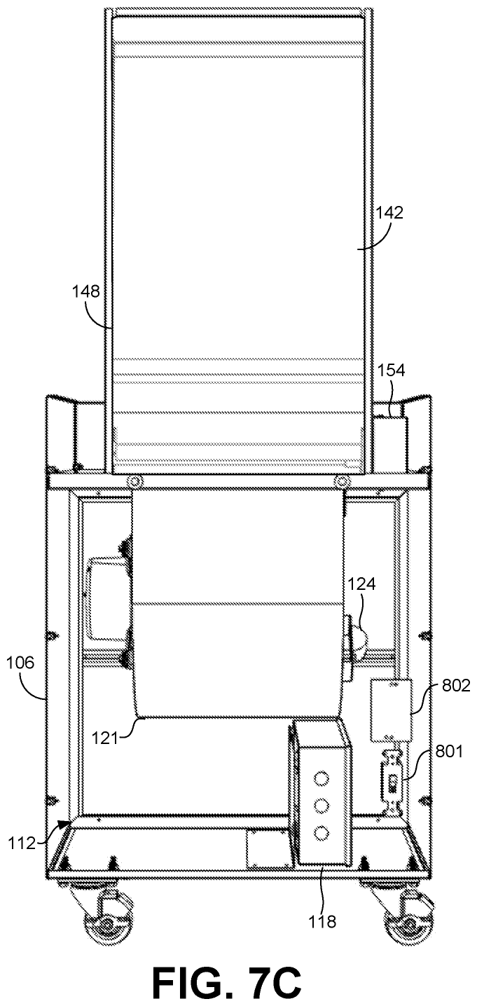

FIGS. 7A-C illustrate examples of fourth side views of the sound-reducing air purification unit, according to various embodiments of the present disclosure. FIG. 7A illustrates an outside of the sound-reducing air purification unit 100 from a fourth side view. FIGS. 7B and 7C illustrate internal components of the sound-reducing air purification unit 100 from a fourth side view.

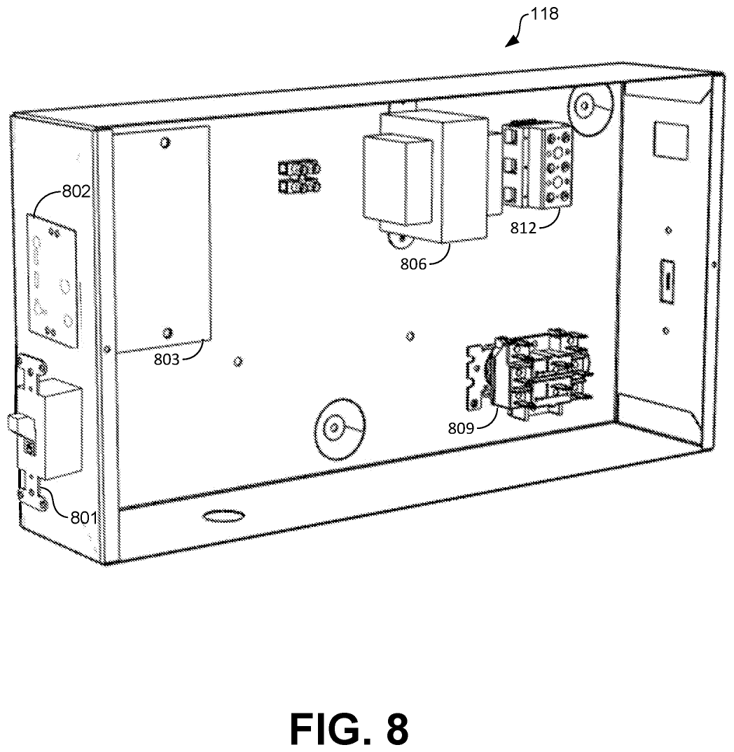

FIG. 8 illustrates an example of an isolated perspective view of a control module 118 of the sound-reducing air purification unit, according to various embodiments of the present disclosure. In the example of FIG. 8, a power switch 801 and an air flow controller 802 are connected to the control module 118. In some examples, however, the power switch 801 and the air flow controller 802 may be separate from the control module 118.

In the example of FIG. 8, the control module 118 includes a control unit 803, a transformer 806, a terminal block 809, and a fan relay 812, but the control module 118 can include different components in other examples. The control unit 803, transformer 806, terminal block 809, and fan relay 812 can be secured to an inside surface of the control module 118. The control unit 803 can be any microcontroller, circuit board, or other electronic device configured control operation of the various functions of the room air purification unit 100. The transformer 806 can be any electrical device designed to supply voltage used to operate the motor of the blower 121. The terminal block 809 can be any device designed to secure wires or any other connections used to operate the motor of the blower 121. The fan relay 812 can be any electrical device designed to relay power used to operate the motor of the blower 121.

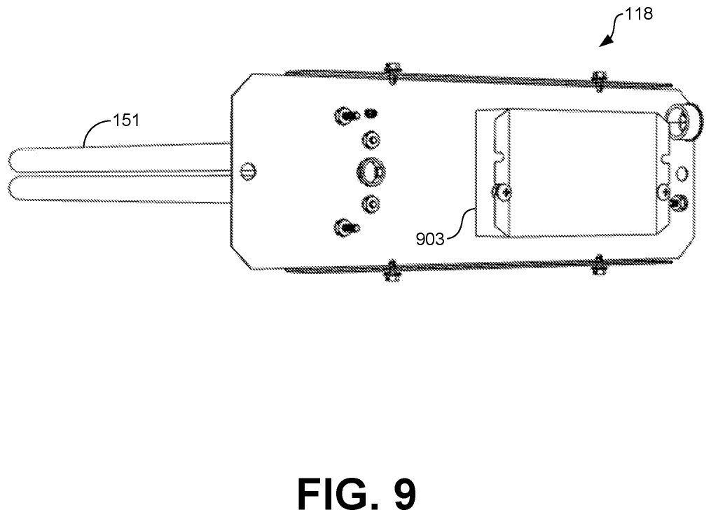

FIG. 9 illustrates an example of an isolated perspective view of an ultraviolet module of the sound-reducing air purification unit, according to various embodiments of the present disclosure. The ultraviolet module 154 can include an ultraviolet ballast 903. The ultraviolet ballast 903 can be any electronic, magnetic, or electro-mechanical device designed to provide voltage sufficient to initiate the emission of ultraviolet radiation from the ultraviolet lamp 151 and to sustain the emission of the ultraviolet radiation during operation of the ultraviolet lamp 151.

A phrase, such as “at least one of X, Y, or Z,” unless specifically stated otherwise, is to be understood with the context as used in general to present that an item, term, etc., can be either X, Y, or Z, or any combination thereof (e.g., X, Y, and/or Z). Similarly, “at least one of X, Y, and Z,” unless specifically stated otherwise, is to be understood to present that an item, term, etc., can be either X, Y, and Z, or any combination thereof (e.g., X, Y, and/or Z). Thus, as used herein, such phrases are not generally intended to, and should not, imply that certain embodiments require at least one of either X, Y, or Z to be present, but not, for example, one X and one Y. Further, such phrases should not imply that certain embodiments require each of at least one of X, at least one of Y, and at least one of Z to be present.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present disclosure defined in the following claims, the scope of which are to be accorded the broadest interpretation so as to encompass modifications and equivalent structures.

Therefore, at least the following is claimed:

1. A sound-reducing air purification unit, comprising:
at least one filter configured to cause a filtration of air when the air flows through the at least one filter;
a blower configured to cause the air to flow through the at least one filter and into an inlet of the blower;
a sound reduction unit positioned between the at least one filter and an outlet, the sound reduction unit being configured to absorb sound emitted by the blower within a lower housing;
a discharge channel configured to channel the air expelled from the blower to a discharge grille;
sound-reducing media positioned on either side of the discharge channel, the sound-reducing media configured to absorb sound emitted by the blower within the discharge channel;
a discharge grille configured to allow the air to flow from the discharge channel into the outlet.

2. The sound-reducing air purification unit of claim 1, further comprising a control module configured to control an operation of the blower.

3. The sound-reducing air purification unit of claim 1, further comprising a bipolar ionization unit configured to produce ions that mix with the air expelled by the blower.

4. The sound-reducing air purification unit of claim 1, further comprising an ultraviolet lamp configured to treat the air expelled from the blower;

5. The sound-reducing air purification unit of claim 4, further comprising an upper housing at least partially enclosing the ultraviolet lamp, the discharge channel, and the sound-reducing media.

6. The sound-reducing air purification unit of claim 5, wherein the upper housing further comprises a plurality of sound reducing chambers respectively positioned adjacent to the discharge channel, wherein the sound-reducing media is integrated into the sound reducing chambers.

7. The sound-reducing air purification unit of claim 1, further comprising a lower housing at least partially enclosing the at least one filter and the blower, wherein the sound reduction unit is secured to the lower housing.

8. The sound-reducing air purification unit of claim 1, wherein the sound reduction unit comprises at least one slot configured to facilitate a passage of the air into the sound-reducing air purification unit and at least one bracket configured to impede the passage of sound through the at least one slot while enabling the passage of the air.

9. The sound-reducing air purification unit of claim 8, wherein the at least one slot comprises a plurality of slots and the at least one bracket comprises a plurality of brackets, wherein each of the slots is associated with a respective bracket, wherein each respective bracket is configured to provide a visual obstruction through a respective one of the slots while allowing air to pass around the bracket and into the sound reduction unit.

10. The sound-reducing air purification unit of claim 1, wherein the discharge channel further comprises a plurality of baffles, wherein the sound-reducing media comprises a perforated sound-reducing material.

11. The sound-reducing air purification unit of claim 1, wherein the discharge channel is oriented to expel air on a top surface of the sound-reducing air purification unit.
